(19) United States
(12) Patent Application Publication
(10) Pub. No.: US 2013/0238433 A1
(43) Pub. Date: Sep. 12, 2013

(54) METHOD AND SYSTEM FOR PROVIDING RELEVANT ADVERTISEMENTS BY MONITORING SCROLL-SPEEDS

(71) Applicant: Gaurav KAMDAR, Bangalore (IN)

(72) Inventor: Gaurav KAMDAR, Bangalore (IN)

(73) Assignee: Yahoo! Inc., Sunnyvale, CA (US)

(21) Appl. No.: 13/415,011

(22) Filed: Mar. 8, 2012

(51) Int. Cl. G06Q 30/02

(52) U.S. Cl. 705/14.53

(57) ABSTRACT

A method and system for providing relevant advertisements by monitoring scroll-speeds. The method includes determining the scroll-speed of a user as the user scrolls through a webpage. The method also includes tagging the scroll-speed to web content on the webpage. Further, the method includes recording the scroll-speed tagged with the web content. Moreover, the method includes targeting the relevant advertisements to the user based on the recording. The system includes one or more electronic devices, a communication interface, a memory, and a processor.

### TECHNICAL FIELD

Embodiments of the disclosure relate to the field of providing relevant advertisements by monitoring scroll-speeds.

### BACKGROUND

Currently, when a user is surfing the Internet, a plurality of advertisements are targeted to the user based on one or more user preferences. However, the user preferences have to be provided by the user by filling appropriate online forms which is a time consuming process. One or more parameters, for example mouse clicks, are presently used to target the advertisements to the user. However, such parameters are intrusive to privacy of the user.

In light of the foregoing discussion, there is a need for a method and system for an efficient and non-intrusive technique to provide relevant advertisements to the user by monitoring scroll-speeds.

### SUMMARY

The above-mentioned needs are met by a method, a computer program product and a system for providing relevant advertisements by monitoring scroll-speeds.

An example of a method of providing relevant advertisements by monitoring scroll-speeds includes determining one or more scroll-speeds of a user as the user scrolls through a webpage. The method also includes tagging the one or more scroll-speeds to web content on the webpage. Further, the method includes recording the one or more scroll-speeds tagged with the web content. Moreover, the method includes targeting the relevant advertisements to the user based on the recording

An example of a computer program product stored on a non-transitory computer-readable medium that when executed by a processor, performs a method of providing relevant advertisements by monitoring scroll-speeds includes determining one or more scroll-speeds of a user as the user scrolls through a webpage. The computer program product also includes tagging the one or more scroll-speeds to web content on the webpage. Further, the computer program product includes recording the one or more scroll-speeds tagged with the web content. Moreover, the computer program product includes targeting the relevant advertisements to the user based on the recording.

An example of a system for providing relevant advertisements by monitoring scroll-speeds includes one or more electronic devices. The system also includes a communication interface in electronic communication with the one or more electronic devices. The system further includes a memory that stores instructions. Further, the system includes a processor responsive to the instructions to determine one or more scroll-speeds of a user as the user scrolls through a webpage, to tag the one or more scroll-speeds to web content on the webpage, to record the one or more scroll-speeds tagged with the web content, and to target the relevant advertisements to the user based on the recording.

The features and advantages described in this summary and in the following detailed description are not all-inclusive, and particularly, many additional features and advantages will be apparent to one of ordinary skill in the relevant art in view of the drawings, specification, and claims hereof. Moreover, it should be noted that the language used in the specification has been principally selected for readability and instructional purposes, and may not have been selected to delineate or circumscribe the inventive subject matter, resort to the claims being necessary to determine such inventive subject matter.

### BRIEF DESCRIPTION OF THE FIGURES

In the following drawings like reference numbers are used to refer to like elements. Although the following figures depict various examples of the invention, the invention is not limited to the examples depicted in the figures.

FIG. 1 is a block diagram of an environment, in accordance with which various embodiments can be implemented;

FIG. 2 is a block diagram of a server, in accordance with one embodiment;

FIG. 3 is a flowchart illustrating a method of providing relevant advertisements by monitoring scroll-speeds, in accordance with one embodiment; and

FIG. 4 is an exemplary illustration of scroll-speeds on a webpage, in accordance with one embodiment.

### DETAILED DESCRIPTION OF THE EMBODIMENTS

The above-mentioned needs are met by a method, computer program product and system for providing relevant advertisements by monitoring scroll-speeds. The following detailed description is intended to provide example implementations to one of ordinary skill in the art, and is not intended to limit the invention to the explicit disclosure, as one or ordinary skill in the art will understand that variations can be substituted that are within the scope of the invention as described.

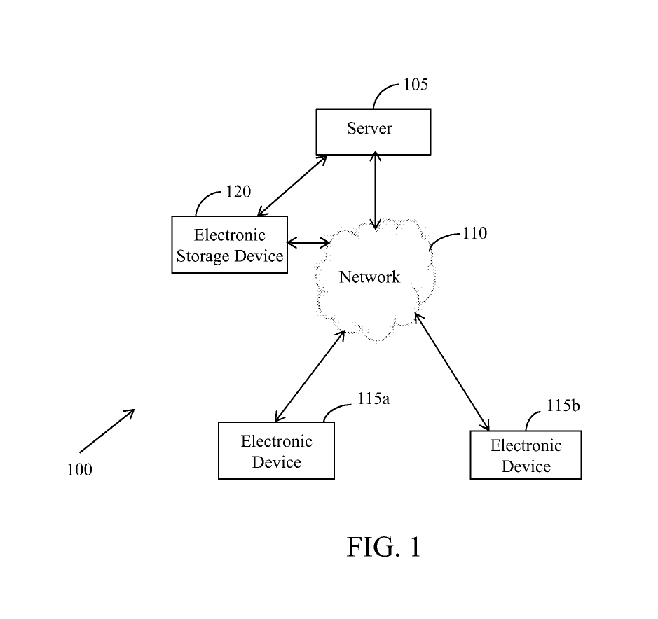

FIG. 1 is a block diagram of an environment 100, in accordance with which various embodiments can be implemented.

The environment 100 includes a server 105 connected to a network 110. The environment 100 further includes one or more electronic devices, for example an electronic device 115a and an electronic device 115b, which can communicate with each other through the network 110. Examples of the electronic devices include, but are not limited to, computers, mobile devices, tablets, laptops, palmtops, hand held devices, telecommunication devices, and personal digital assistants (PDAs).

The electronic devices can communicate with the server 105 through the network 110. Examples of the network 110 include, but are not limited to, a Local Area Network (LAN), a Wireless Local Area Network (WLAN), a Wide Area Network (WAN), internet, and a Small Area Network (SAN). The electronic devices associated with different users can be remotely located with respect to the server 105.

The server 105 is also connected to an electronic storage device 120 directly or via the network 110 to store information, for example scroll-speeds of a user tagged with web content on a webpage, and one or more advertisements.

In some embodiments, different electronic storage devices are used for storing the information.

A user of an electronic device, for example the electronic device 115a, views web content on a webpage by scrolling through the web content. The server 105, for example a Yahoo!® server, determines one or more scroll-speeds of the user as the user scrolls through the webpage. The server 105 tags the one or more scroll-speeds to the web content on the webpage. The scroll-speeds tagged with the web content are then recorded in the electronic storage device 120. The server 105 further targets relevant advertisements to the user based on recording. The relevant advertisements are selected and retrieved from advertisements stored in the electronic storage device 120.

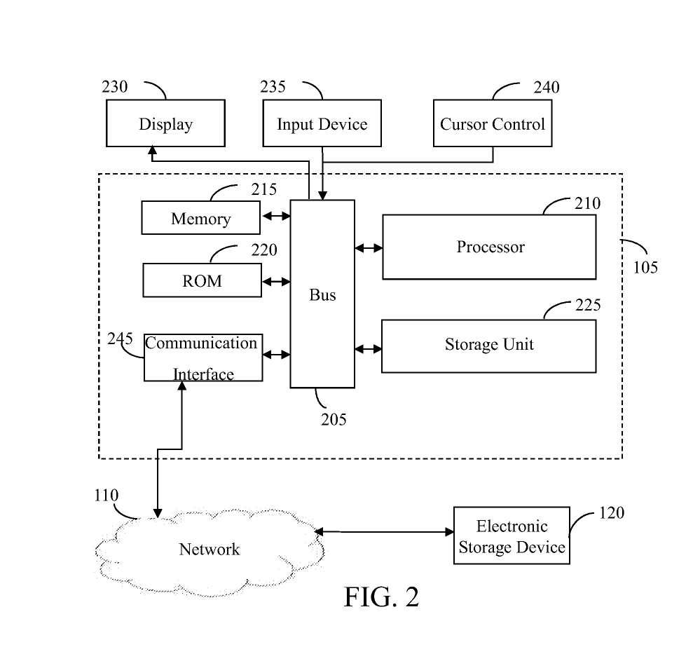

The server 105 including a plurality of elements is explained in detail in conjunction with FIG. 2.

FIG. 2 is a block diagram of the server 105, in accordance with one embodiment.

The server 105 includes a bus 205 or other communication mechanism for communicating information, and a processor 210 coupled with the bus 205 for processing information. The server 105 also includes a memory 215, for example a random access memory (RAM) or other dynamic storage device, coupled to the bus 205 for storing information and instructions to be executed by the processor 210. The memory 215 can be used for storing temporary variables or other intermediate information during execution of instructions by the processor 210. The server 105 further includes a read only memory (ROM) 220 or other static storage device coupled to the bus 205 for storing static information and instructions for the processor 210. A storage unit 225, for example a magnetic disk or optical disk, is provided and coupled to the bus 205 for storing information, for example scroll-speeds of a user tagged with web content on a webpage, and one or more advertisements.

The server 105 can be coupled via the bus 205 to a display 230, for example a cathode ray tube (CRT), and liquid crystal display (LCD) for displaying the webpage. An input device 235, including alphanumeric and other keys, is coupled to the bus 205 for communicating information and command selections to the processor 210. Another type of user input device is a cursor control 240, for example a mouse, a trackball, or cursor direction keys for communicating direction information and command selections to the processor 210 and for controlling cursor movement on the display 230. The input device 235 can also be included in the display 230, for example a touch screen. A scroll input, for example human touch, a scroll key, and a mouse scroll, can be provided to the input device 235 to determine the scroll-speeds.

Various embodiments are related to the use of the server 105 for implementing the techniques described herein. In some embodiments, the techniques are performed by the server 105 in response to the processor 210 executing instructions included in the memory 215. Such instructions can be read into the memory 215 from another machine-readable medium, for example the storage unit 225. Execution of the instructions included in the memory 215 causes the processor 210 to perform the process steps described herein.

In some embodiments, the processor 210 can include one or more processing units for performing one or more functions of the processor 210. The processing units are hardware circuitry used in place of or in combination with software instructions to perform specified functions.

The term “machine-readable medium” as used herein refers to any medium that participates in providing data that causes a machine to perform a specific function. In an embodiment implemented using the server 105, various machine-readable media are involved, for example, in providing instructions to the processor 210 for execution. The machine-readable medium can be a storage medium, either volatile or non-volatile. A volatile medium includes, for example, dynamic memory, such as the memory 215. A non-volatile medium includes, for example, optical or magnetic disks, for example the storage unit 225. All such media must be tangible to enable the instructions carried by the media to be detected by a physical mechanism that reads the instructions into a machine.

Common forms of machine-readable media include, for example, a floppy disk, a flexible disk, hard disk, magnetic tape, or any other magnetic media, a CD-ROM, any other optical media, punchcards, papertape, any other physical media with patterns of holes, a RAM, a PROM, and EPROM, a FLASH-EPROM, any other memory chip or cartridge.

In another embodiment, the machine-readable media can be transmission media including coaxial cables, copper wire and fiber optics, including the wires that comprise the bus 205. Transmission media can also take the form of acoustic or light waves, such as those generated during radio-wave and infra-red data communications. Examples of machine-readable media may include, but are not limited to, a carrier wave as described hereinafter or any other media from which the server 105 can read, for example online software, download links, installation links, and online links. For example, the instructions can initially be carried on a magnetic disk of a remote computer. The remote computer can load the instructions into its dynamic memory and send the instructions over a telephone line using a modem. A modem local to the server 105 can receive the data on the telephone line and use an infra-red transmitter to convert the data to an infra-red signal. An infra-red detector can receive the data carried in the infra-red signal and appropriate circuitry can place the data on the bus 205. The bus 205 carries the data to the memory 215, from which the processor 210 retrieves and executes the instructions. The instructions received by the memory 215 can optionally be stored on the storage unit 225 either before or after execution by the processor 210. All such media must be tangible to enable the instructions carried by the media to be detected by a physical mechanism that reads the instructions into a machine.

The server 105 also includes a communication interface 245 coupled to the bus 205. The communication interface 245 provides a two-way data communication coupling to the network 110. For example, the communication interface 245 can be an integrated services digital network (ISDN) card or a modem to provide a data communication connection to a corresponding type of telephone line. As another example, the communication interface 245 can be a local area network (LAN) card to provide a data communication connection to a compatible LAN. Wireless links can also be implemented. In any such implementation, the communication interface 245 sends and receives electrical, electromagnetic or optical signals that carry digital data streams representing various types of information.

The server 105 is also connected to the electronic storage device 120 to store the scroll-speeds of the user tagged with the web content, and the advertisements.

The processor 210 in the server 105, for example a Yahoo!® server, determines one or more scroll-speeds of a user as the user scrolls through a webpage. The processor 210 tags the scroll-speeds to the web content on the webpage. The scroll-speeds tagged with the web content are then recorded in the storage unit 225 or the electronic storage device 120. The processor 210 further targets relevant advertisements to the user based on recording. The relevant advertisements are selected and retrieved from the advertisements stored in the storage unit 225 or the electronic storage device 120.

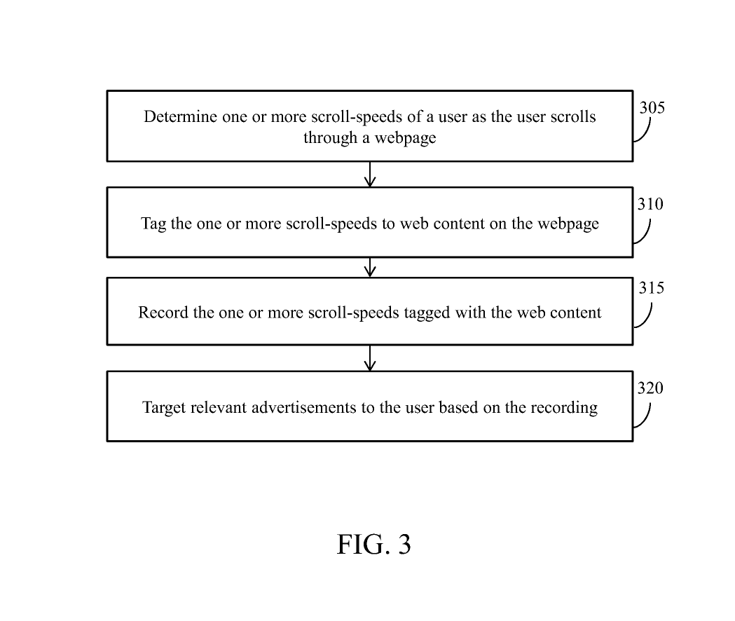

FIG. 3 is a flowchart illustrating a method of providing relevant advertisements by monitoring scroll-speeds, in accordance with one embodiment.

At 305, one or more scroll-speeds of a user are determined as the user scrolls through a webpage. The scroll-speeds include one or more of horizontal scroll-speeds and vertical scroll-speeds. The webpage includes web content in different horizontal sectors of a screen. Examples of the web content include, but are not limited to, advertisements, and data. Examples of the data include, but are not limited to, textual information, non-textual information, and interactive information.

In some embodiments, the textual information is displayed in extensible markup language (XML) format or in hypertext markup language (HTML) format. In some embodiments, the non-textual information is displayed as images, audio, or video format. In some embodiments, the interactive information is displayed in Dynamic HTML (DHTML) format.

In some embodiments, the user scrolls through the webpage by providing a scroll input, for example human touch, a scroll key, and a mouse scroll.

At 310, the scroll-speeds are tagged to the web content on the webpage. If the user is less interested in the web content present in a horizontal sector, the user tends to scroll over the horizontal sector at a high scroll-speed. Similarly, if the user is highly interested in the web content present in the horizontal sector, the user tends to scroll over the horizontal sector at a low scroll-speed. Hence high scroll-speeds are tagged to the web content having less user interest and low scroll-speeds are tagged to the web content having high user interest.

In some examples, the scroll-speeds can be tagged to advertisement content, brand, product metrics, and product data.

At 315, the scroll-speeds tagged with the web content are recorded. The web content thus recorded enables a learning process for providing the relevant advertisements.

In some embodiments, the scroll speeds tagged to the web content can be recorded or stored in an electronic storage device, for example the electronic storage device 120.

In some embodiments, the scroll speeds tagged to the web content can be recorded or stored in and retrieved from a storage unit, for example the storage unit 225, in a server, for example the server 105. In one example, the server can be a centralized server or a distributed server of Yahoo!®.

At 320, target the relevant advertisements to the user based on the recording. The user can then view the relevant advertisements.

The scroll-speeds are first compared to determine a low scroll-speed. The relevant advertisements associated with the web content tagged to the low scroll-speed are then targeted to the user. If there are multiple low scroll-speeds, the multiple low scroll-speeds can be prioritized and the relevant advertisements can be targeted accordingly.

In some embodiments, the advertisements can be recorded or stored in the electronic storage device 120 or the storage unit 225. The relevant advertisements are then selected from the advertisements and subsequently retrieved from the electronic storage device 120 or the storage unit 225.

In some embodiments, the relevant advertisements can be displayed on the webpage instantly. In other embodiments, the relevant advertisements can be displayed on another webpage in near future.

In some embodiments, the relevant advertisements can be displayed as polyads.

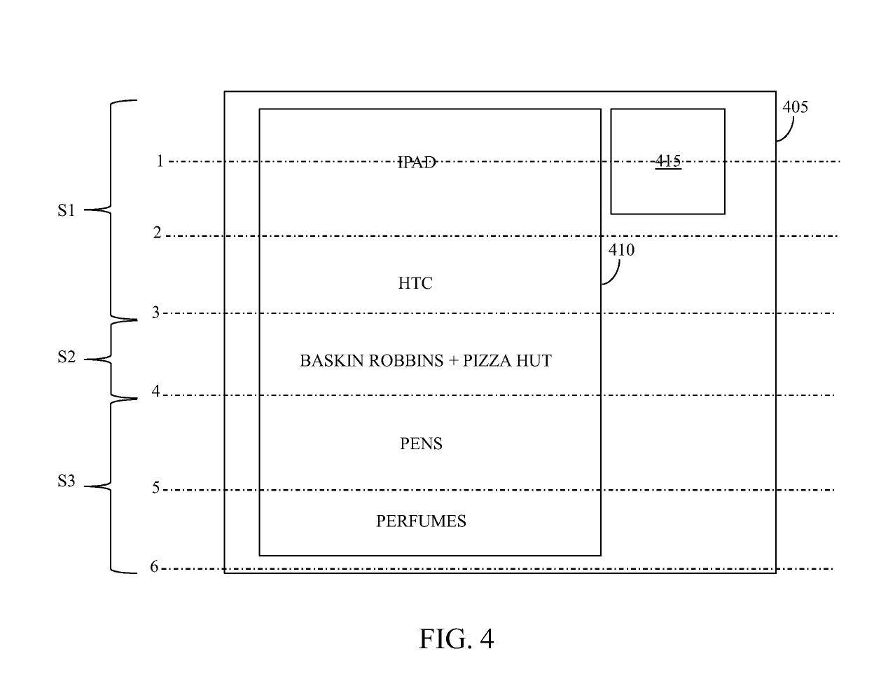

FIG. 4 is an exemplary illustration of the scroll-speeds on the web page, for example a webpage 405, in accordance with one embodiment. The webpage 405 includes an article 410 and an advertisement 415. A screen is divided into horizontal sectors, for example sectors 1 to 6.The article 410 provides information on different topics. For example, the article provides information on iPad in sectors 1 and 2, on HTC in sector 3, on Baskin Robbins and Pizza Hut in sector 4, on pens in sector 5, and on perfumes in sector 6. The advertisement 415 is further present in sectors 1 and 2.

The user is not interested in the information on the iPad and the HTC and hence scrolls through sectors 1, 2 and 3 at a high scroll-speed S1. When the user reaches the information on Baskin Robbins and Pizza Hut in sector 4, the user shows interest and scrolls through the sector 4 at a low scroll-speed S2. Further, the user is not interested in the information on the pens and the perfumes and hence scrolls through sectors 5 and 6 at a high scroll-speed S3. The scroll-speeds, S1, S2, and S3 are then tagged to associated information and subsequently recorded.

As S2 is the low scroll-speed, the relevant advertisements corresponding to Baskin Robbins and Pizza Hut are targeted to the user either in the webpage 405 or in a future webpage. As S1 and S3 are high scroll-speeds, the advertisements associated with the information in sectors 1, 2, 3, 5 and 6 are either terminated or put on hold. Hence, the relevant advertisements can be targeted to the user based on the scroll-speeds and interest of the user.

The present disclosure provides relevant advertisements to a user by monitoring scroll-speeds. The present disclosure enables advertisers to be aware of marketing potential of advertisements based on the scroll-speeds of the user. Yahoo! uses the scroll-speeds as a parameter to increase user experience for viewing web content. Further, the monitoring of the scroll-speeds is a non-intrusive method to determine user interest. Hence, the method and system in the present disclosure enables Yahoo! to introduce higher accuracy in serving the relevant advertisements to the users.

It is to be understood that although various components are illustrated herein as separate entities, each illustrated component represents a collection of functionalities which can be implemented as software, hardware, firmware or any combination of these. Where a component is implemented as software, it can be implemented as a standalone program, but can also be implemented in other ways, for example as part of a larger program, as a plurality of separate programs, as a kernel loadable module, as one or more device drivers or as one or more statically or dynamically linked libraries.

As will be understood by those familiar with the art, the invention may be embodied in other specific forms without departing from the spirit or essential characteristics thereof. Likewise, the particular naming and division of the portions, modules, agents, managers, components, functions, procedures, actions, layers, features, attributes, methodologies and other aspects are not mandatory or significant, and the mechanisms that implement the invention or its features may have different names, divisions and/or formats.

Furthermore, as will be apparent to one of ordinary skill in the relevant art, the portions, modules, agents, managers, components, functions, procedures, actions, layers, features, attributes, methodologies and other aspects of the invention can be implemented as software, hardware, firmware or any combination of the three. Of course, wherever a component of the present invention is implemented as software, the component can be implemented as a script, as a standalone program, as part of a larger program, as a plurality of separate scripts and/or programs, as a statically or dynamically linked library, as a kernel loadable module, as a device driver, and/or in every and any other way known now or in the future to those of skill in the art of computer programming. Additionally, the present invention is in no way limited to implementation in any specific programming language, or for any specific operating system or environment.

Furthermore, it will be readily apparent to those of ordinary skill in the relevant art that where the present invention is implemented in whole or in part in software, the software components thereof can be stored on computer readable media as computer program products. Any form of computer readable medium can be used in this context, such as magnetic or optical storage media. Additionally, software portions of the present invention can be instantiated (for example as object code or executable images) within the memory of any programmable computing device.

Accordingly, the disclosure of the present invention is intended to be illustrative, but not limiting, of the scope of the invention, which is set forth in the following claims.

What is claimed is:

1. A method of providing relevant advertisements by monitoring scroll-speeds, the method comprising:
determining one or more scroll-speeds of a user as the user scrolls through a webpage;
tagging the one or more scroll-speeds to web content on the webpage;
recording the one or more scroll-speeds tagged with the web content; and
targeting the relevant advertisements to the user based on the recording.

2. The method as claimed in claim 1, wherein the one or more scroll-speeds comprises one or more of horizontal scroll-speeds and vertical scroll-speeds.

3. The method as claimed in claim 1, wherein the web content comprises advertisements and data.

4. The method as claimed in claim 1, wherein tagging the one or more scroll-speeds to the web content comprises:
tagging high scroll-speeds to the web content having less user interest; and
tagging low scroll-speeds to the web content having high user interest.

5. The method as claimed in claim 1, wherein recording the one or more scroll-speeds tagged with the web content enables a learning process for providing the relevant advertisements.

6. The method as claimed in claim 1, wherein targeting the relevant advertisements to the user comprises
comparing the one or more scroll-speeds to determine a low scroll-speed; and
targeting, to the user, the relevant advertisements associated with the low scroll-speed.

7. A computer program product stored on a non-transitory computer-readable medium that when executed by a processor, performs a method of providing relevant advertisements by monitoring scroll-speeds, comprising:
determining one or more scroll-speeds of a user as the user scrolls through a webpage;
tagging the one or more scroll-speeds to web content on the webpage;
recording the one or more scroll-speeds tagged with the web content; and
targeting the relevant advertisements to the user based on the recording.

8. The computer program product as claimed in claim 7, wherein the one or more scroll-speeds comprises one or more of horizontal scroll-speeds and vertical scroll-speeds.

9. The computer program product as claimed in claim 7, wherein the web content comprises advertisements and data.

10. The computer program product as claimed in claim 7, wherein tagging the one or more scroll-speeds to the web content comprises:
tagging high scroll-speeds to the web content having less user interest; and
tagging low scroll-speeds to the web content having high user interest.

11. The computer program product as claimed in claim 7, wherein recording the one or more scroll-speeds tagged with the web content enables a learning process for providing the relevant advertisements.

12. The computer program product as claimed in claim 7, wherein targeting the relevant advertisements to the user comprises
comparing the one or more scroll-speeds to determine a low scroll-speed; and
targeting, to the user, the relevant advertisements associated with the low scroll-speed.

13. A system for providing relevant advertisements by monitoring scroll-speeds, the system comprising:
one or more electronic devices;
a communication interface in electronic communication with the one or more electronic devices;
a memory that stores instructions; and
a processor responsive to the instructions to
determine one or more scroll-speeds of a user as the user scrolls through a webpage;
tag the one or more scroll-speeds to web content on the webpage;
record the one or more scroll-speeds tagged with the web content; and
target the relevant advertisements to the user based on the recording.

14. The system as claimed in claim 13 and further comprising
an electronic storage device that stores the one or more scroll-speeds of the user tagged with the web content, and one or more advertisements.

15. The system as claimed in claim 13, wherein the one or more scroll-speeds of the user are determined based on a scroll input.

16. The system as claimed in claim 13, wherein the one or more scroll-speeds comprises one or more of horizontal scroll-speeds and vertical scroll-speeds.

17. The system as claimed in claim 13, wherein the web content comprises advertisements and data.
